(19) United States
(12) Patent Application Publication
(10) Pub. No.: US 2010/0239406 A1
(43) Pub. Date: Sep. 23, 2010

(54) UNDERWATER EQUIPMENT RECOVERY

(75) Inventor: Jonathan Harvey Nicholls, Aberdeen (GB)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: OHM LIMITED, Aberdeen (GB)

(21) Appl. No.: 12/161,199

(22) PCT Filed: Dec. 21, 2006
(86) PCT No.: PCT/GB06/04879

§ 371 Date: Aug. 19, 2008

(30) Foreign Application Priority Data
Jan. 20, 2006 (GB) 0601199.3

(51) Int. Cl. B63C 7/16; B63C 7/18; B66C 1/10

(52) U.S. Cl. 414/800; 294/66.1

(57) ABSTRACT

An apparatus and method for recovering equipment from within a body of water. The apparatus comprises a frame supporting a mesh and an engagement element. The engagement element is shaped to co-engage with the mesh and is attached to the equipment to be recovered prior to its deployment. Following deployment of the equipment, its recovery can be effected by lowering the mesh supported by the frame onto the equipment to cause the engagement element and the mesh to co-engage. The frame and mesh may then be lifted to the surface of the water bringing the equipment with them. Recovery may include searching for the equipment by monitoring a load associated with the frame and the mesh as it is lowered and raised at different locations, whereby an appropriate increase in load is taken to indicate that the equipment has become attached to the mesh.

### BACKGROUND OF THE INVENTION

The invention relates to the recovery of underwater equipment, for example equipment which has been deployed on the seafloor during surveying.

Equipment can be placed on (or moored to) the seafloor, or towed at depth, for a variety of reasons. For example, equipment is often deployed underwater during sub-sea construction, for oil and mineral exploration, geological exploration, meteorological and oceanic monitoring and for assisting vessel navigation. A standard method for recovering such equipment relies on acoustically activated release mechanisms.

FIG. 1A schematically shows a known electromagnetic receiver 2 which is deployed on the seafloor 4 during an electromagnetic survey and recovered at the end of the survey using known techniques (GB 2 382 875 [1]). A similar system is also described in U.S. Pat. No. 5,770,945 [2]. The receiver 2 has a main body 6 comprising antennae 12, instrument housing 14, and floatation device 16. The floatation device 16 comprises a pair of air-filled containers. The main body 6 is connected to a concrete ballast weight 8 via releasable connector 10 comprising an acoustic release mechanism. The receiver 2 is deployed by being dropped overboard from a support ship (not shown). The ballast weight 8 is sufficient to overcome the buoyancy of the floatation device 16 and the receiver 2 sinks to, and settles on, the seafloor 4. An electromagnetic survey may then be performed with the receiver 2 collecting data and recording it in a memory within the instrument housing 14. In a typical survey many such receivers will be distributed over an area of seafloor of interest.

The releasable connector 10 is designed to release in response a remotely transmitted acoustic signal. Thus, and at the end of a survey, in order to recover the recoverable parts of the receiver 2, the support ship broadcasts the appropriate acoustic signal causing the releasable connector 10 to release.

FIG. 1B schematically shows the receiver of FIG. 1A soon after activation of the releasable connector 10. On activation of the releasable connector 10, the main body 6 is no longer attached to the ballast weight 8. Thus, the main body 6 floats to the surface under the buoyancy provided the floatation device 16, as schematically indicated by arrow 20. Once at the surface of the water, the main body may be collected by the support ship. The ballast weight 8 remains on the seafloor.

There are a number of disadvantages with this approach.

Firstly, the ballast weight 8 remains on the seafloor. Not only does this increase the cost of re-deployment (since a new ballast weight is required each time) there are ecological implications.

Secondly, acoustic release mechanisms are not completely reliable. This can leave often very expensive equipment (and data within it) stranded on the seafloor. In such cases, the equipment is either written-off as lost (with ecological as well as financial implications), or is recovered using an alternative method. One alternative is to drag a grappling hook over the general area of loss. However, this is time consuming and damaging to structures on the seafloor, both natural and man-made. Furthermore, in some cases, e.g. in the vicinity of sensitive installations such as are often found in a producing oil field, this approach may not be possible at all. Another alternative is to use expensive remotely operated sub-sea vehicles, although these are often limited by depth and/or lifting capacity, to retrieve stranded equipment. In shallow water, divers can be used to attach lines to lost equipment. However, this is again expensive and time consuming.

In other examples, in place of a ballast weight, the part of the equipment to be recovered may be anchored to a fixed mooring on the seafloor using an acoustically releasable connector. Nonetheless, the same considerations as described above apply.

In some cases, the equipment to be recovered may not have been intended for seafloor deployment, but may have been accidentally deployed, e.g. because it was dropped, or came free of its moorings and did not include a floatation device. Since the equipment was not intended for remote seafloor deployment, it is unlikely to have been provided with a recovery system of the kind shown in FIGS. 1A and 1B since these can be expensive and bulky yet of no use in normal operations. Thus equipment lost in this way can only be recovered using other means, e.g. by grappling, or using a remote sub-sea vehicle and/or divers as described above.

EP 1188662 [3] discloses a floating net into which a powered vehicle may be driven to allow it to be recovered. However, this scheme only allows for the recovery of self-powered vehicles from the surface of a body of water and cannot be used to recover equipment deployed underwater.

GB 2279619 [4] discloses an apparatus and method for capturing floating objects. Again, this cannot be used to recover equipment deployed underwater.

U.S. Pat. No. 6,843,191 [5] discloses a device and methods for raising sunken objects. A lifting net is guided onto a previously located object by a series of cables anchored to the seafloor in its vicinity. Seawater surrounding the object is then frozen by a cryogenic freezing unit. When a layer of ice has formed around the object, the net is closed around it and the object is lifted to the surface. However, this scheme is complex and requires the location of the object to be known in advance.

### SUMMARY OF THE INVENTION

According to a first aspect of the invention, there is provided a method for recovering underwater equipment comprising: attaching an engagement element to the equipment prior to its deployment; and, following deployment of the equipment: lowering a mesh supported by a frame onto the equipment to cause the engagement element and the mesh to co-engage; and lifting the frame and the mesh and the equipment attached thereto upwards to recover the equipment.

The method may provide the primary means for recovering underwater equipment modules or a fall-back in the event that a conventional recovery method fails. Furthermore, the method may be used with equipment which is not intended for deployment underwater but which has undergone an accidental deployment, e.g. because of dropping. This is because cheap and simple engagement elements can be attached to any equipment which may be accidentally dropped, e.g. from a surface vessel.

Unlike conventional acoustic release systems, the method avoids the need to leave ballast weights on the seafloor and so can be used as the primary means of recovery when it is particularly desired to avoid this. The method is cheaper and safer and subject to less stringent water-depth limitations than recovery methods relying on divers or remotely operated vehicles. Furthermore, the method inflicts little or no damage to existing installations and the bed of the body of water from which equipment is to be recovered compared with methods based on trawling a grapple.

The method may be employed to recover equipment from a range of water depths, for example from a depth of at least 100 m, 200 m, 300 m, 400 m, 500 m, 1000 m, and 2000 m, with or without using positioning transponders. Specifically, the method has been successfully tested to recover equipment from a water depth of 1900 m without using positioning transponders. However, there is no real practical limit to the depth from which equipment may be recovered using the method. Current exploration typically extends to water depth of 4000 m, and the method can be used to this depth and beyond.

The frame can have a range of suitable areas. The frame area can be as small as 4 m², but is more preferably at least 10 m² or 20 m². The frame area can be as large as 100 m² or indeed larger still, but is more typically 50 m² or less. The frame area can also be provided in a variety of shapes (as considered in plan view when deployed), such as square, rectangular or other polygonal shape, or circular or oval.

The method may be used to recover equipment of any kind. One application of the method is in the recovery of receivers deployed during surveying, for example, electromagnetic receivers deployed during an electromagnetic survey or seismic receivers deployed during a seismic survey. Surveys such as these often employ an array of receivers deployed over a large area on the floor of a body of water. This means relatively large numbers of receiver deployments and recoveries are often needed for a survey. Furthermore, an individual receiver will typically be deployed and recovered many times during its operational lifetime. Thus reliable recovery of survey receivers is particularly useful.

The method may further comprise monitoring a load associated with the frame and mesh to determine whether they are supporting the weight of the equipment. For example, an increase in measured load as the frame and mesh are lifted compared to the load seen when they were being lowered can be used to indicate that the equipment has become attached to the mesh through the engagement element and may be lifted to the surface. In particular, the static load (i.e. that seen when there is pause in the lifting or lowering, or when the frame is being lowered or lifted at a constant speed) will be most sensitive to changes in weight associated with the equipment becoming attached to the mesh via the engagement element.

For example, a lifting mechanism operable to raise and lower the frame and the mesh in the water (e.g. a winch and crane aboard a ship) may be provided with a load cell configured to measure the tension in a lifting cable attached to the frame. It will be generally be simpler to locate the load cell at the winch end of the lifting cable. However, if the weight of the lifting cable is significant, it may be preferable to position the load cell on the cable nearer to the frame and mesh (or on the frame and/or mesh) so that the weight of the cable does not dominate the measured load.

The frame and mesh may be lowered and raised multiple times at a location to improve the chance of the engagement element and the mesh co-engaging.

In cases where the location of the equipment is not known precisely, the method may further comprise searching for the equipment by lowering and lifting the frame and mesh at different locations until an increase in load indicates that the equipment has become attached to the mesh via the engagement element and is ready to be lifted.

To reduce the risk of damage to the equipment during searching, the frame and mesh may be maintained at a height greater than that of the equipment and attached engagement element when they are being moved between locations.

Furthermore, the distance between one location and a subsequent location may be selected to be less than the width of the frame to help avoid missing areas of the bed of water during the search. The frame size can chosen according to the area to be searched and areas can be covered more quickly and effectively that with traditional grappling methods.

According to a second aspect of the invention, there is provided an apparatus for recovering equipment from within a body of water, comprising a frame supporting a mesh and an engagement element configured to be attached to equipment to be recovered prior to the equipment's deployment, and shaped to co-engage with the mesh in the event that the mesh is lowered onto the engagement element.

The apparatus of the second aspect of the invention may be used to implement the method of the first aspect of the invention.

The engagement element can take a variety of forms, for example, it may have an end in the form of an arrow head, or one or more hooks or barbs, for example.

The mesh may be flexible, e.g., formed of polypropylene rope or steel cabling so that the frame and mesh easily disassembled and packed in to a smaller area when not in use, e.g. when stored on the deck of a ship. Alternatively, the mesh may be rigid, for example where particularly heavy loads are expected.

The engagement element may also be provided with a buoyancy device so that its orientation is maintained when it is submerged regardless of the orientation of the equipment to which it is attached. This can help ensure the engagement element is appropriately positioned to engage with the mesh when the orientation adopted by the deployed equipment on the bed of a body of water is not known in advance. Alternatively (or in addition), multiple engagement elements extending in different directions may be used.

The engagement element and/or the frame or mesh may include a position transponder. These can help improve the speed of recovery by providing information on the absolute or relative positions of the engagement element and the frame and mesh.

According to a third aspect of the invention there is provided an item if equipment to which the engagement element of the second aspect of the invention has been attached.

### BRIEF DESCRIPTION OF THE DRAWINGS

For a better understanding of the invention and to show how the same may be carried into effect reference is now made by way of example to the accompanying drawings in which:

FIG. 1A schematically shows in section view an electromagnetic receiver to be recovered from the seafloor according to the prior art;

FIG. 1B shows the receiver of FIG. 1A soon after the procedure for recovering it has been instigated;

FIG. 2 schematically shows in section view an item of equipment to be recovered from the seafloor and an engagement element of an apparatus for recovering it according to an embodiment of the invention;

FIG. 3 schematically shows in perspective view a frame and mesh of an apparatus according to an embodiment of the invention to be used in conjunction with the engagement element shown in FIG. 2;

FIG. 4 schematically shows a ship seeking to recover equipment according to an embodiment of the invention;

FIG. 5 schematically shows an area of seafloor in which equipment to be recovered is located;

FIG. 6 is similar to FIG. 4 but schematically shows the situation when recovery of the equipment is soon to start;

FIG. 7 is similar to FIG. 6 but schematically shows the situation when recovery of the equipment is underway;

FIG. 8 shows the engagement element of FIG. 2 co-engaging with the mesh of FIG. 3 during recovery of the equipment;

FIGS. 9A, 9B and 9C schematically show alternative engagement elements according to embodiments of the invention; and

FIG. 10 schematically shows an engagement element including a buoyancy device in accordance with an embodiment of the invention.

### DETAILED DESCRIPTION

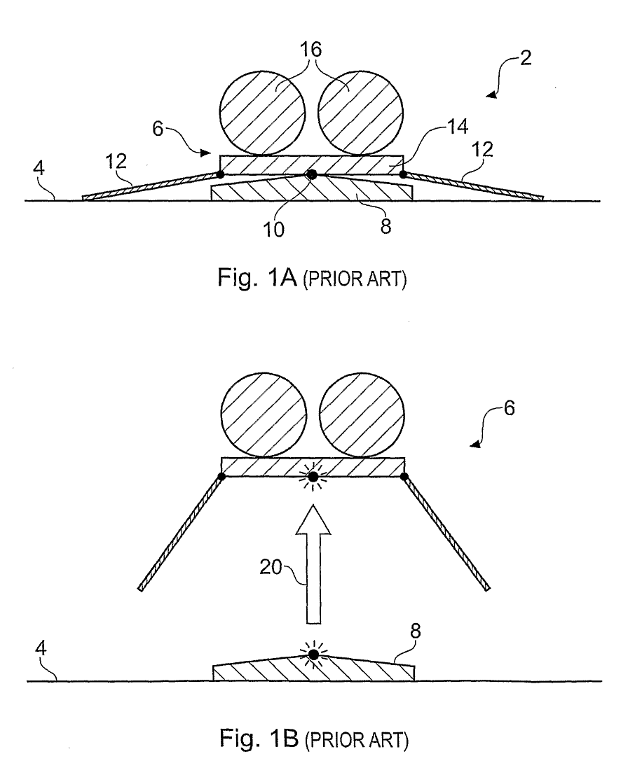

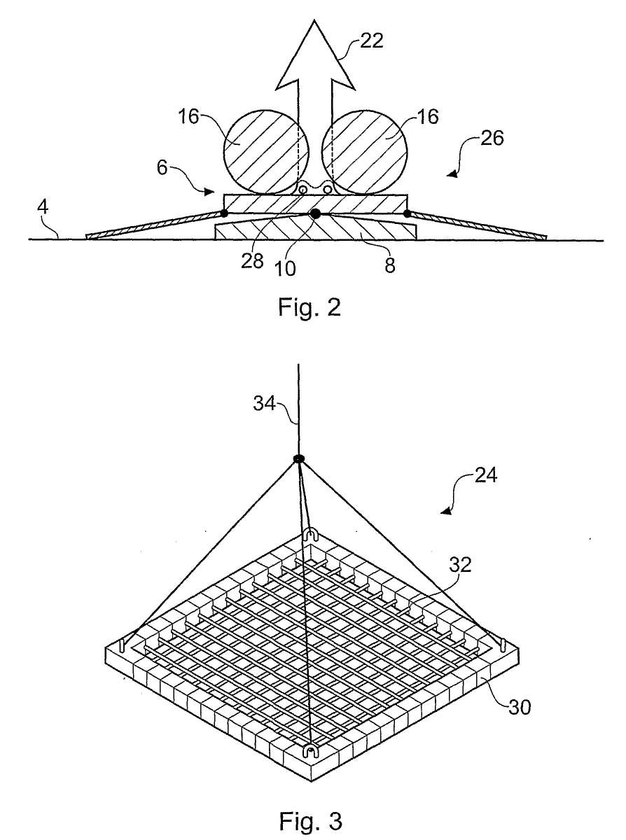

FIGS. 2 and 3 schematically show an apparatus 22, 24 for recovering equipment deployed underwater according to an embodiment of the invention. In this example, the equipment is an equipment module constituting an electromagnetic receiver 26 lying on the seafloor 4. The receiver is similar to and will be understood from the electromagnetic receiver 2 shown in FIG. 1. That is to say the receiver 26 includes a conventional recovery mechanism comprising a floatation device 16, a ballast weight 8 and a releasable connector 10 as described above. Thus the apparatus 22, 24 is for recovering the receiver in the event that the conventional recovery mechanism fails. It will be appreciated that in other examples the receiver (or other equipment) may not include a conventional recovery mechanism and the apparatus 22, 24 will be the primary means for recovering the equipment. The principle underlying the recovery procedure will be the same in both of these cases.

The apparatus comprises two parts, a first part shown in FIG. 2 is an engagement element 22, referred to in this embodiment as a harpoon. The harpoon 22 is attached to the receiver using fixings 28. This done before the receiver is deployed. Any conventional form of fixing may be employed, e.g. the harpoon 22 may be welded or bolted to a flange or bracket of the receiver 26. The harpoon 22 is in a generally planar form and has an end distal the end fixed to the receiver which is formed into the shape of an arrow head. The harpoon 22 (and the fixings 28) are such that the weight of the receiver 26 can be supported by the harpoon. In addition, if significant dynamic forces are expected during recovery (e.g. due to current flows and surface vessel heave), or if the receiver is likely to be deployed in a region of mud or silt such that there will be a sucking force as it is lifted away from the seafloor, the harpoon 22 and fixings 28 should be designed to be able to accommodate these additional forces. The harpoon is arranged so that when the receiver is normally deployed on the seafloor, the arrow head is pointing upwards and extends to a height above neighbouring parts of the receiver 26.

A second part of the apparatus is shown in FIG. 3 and comprises a frame 30 supporting a mesh 32 and support cabling 34 (e.g. a chain bridle) attached to the frame. The combined frame 30, mesh 32 and support cabling 34 part of the apparatus are collectively referred to in this embodiment as a picker 24. The picker 24 can be raised and lowered in the water column using a lifting mechanism (not shown in FIG. 3) with the frame 30 and mesh 32 remaining substantially horizontal. The lifting mechanism will typically comprise a winch and jib/crane arrangement on a surface vessel to which the receiver is to be recovered.

The frame 30 in this example is of a generally square shape. It is of a robust construction, e.g. formed of steel pipe or solid bar section, with lifting points on the corners. The frame 30 should be able to bear the weight of the equipment to be recovered (and any expected additional forces as mentioned above). It will be advantageous to shape the frame so as to minimize drag as the frame moves in the water column as much as possible. The frame may be pre-fabricated or may be formed of sections to be assembled when required in order to reduce the storage space required when not in use.

The mesh 32 in this example comprises netting formed from polypropylene rope strung between the sides of the frame 30. Other netting materials, such as high performance synthetic rope or steel rope, for example, could also be used. The netting should be able to bear the weight of the equipment to be recovered (and any additional forces likely to be experienced). Although shown taut in FIG. 3, there is no particular need for the mesh to be strung to any particular tightness.

During recovery of equipment, and as explained further below, the harpoon and the mesh co-engage with one another and thus allow the equipment to be lifted from the floor of the body of water. Thus the sizes of the openings in the mesh and the size of the engaging part of the harpoon (i.e. the arrow head in this embodiment) are chosen so that the engaging part can pass easily through the mesh in the forward direction (that is as the picker is lowered down onto the harpoon), but has a high chance of becoming snagged on (i.e. co-engaging with) the mesh as the picker is subsequently lifted away from the seafloor, thus enabling the receiver to come away with it. This can be achieved, for example, if the width of the arrow head between the tips of is barbs (i.e. it's greatest extent) broadly corresponds to the characteristic size of the openings in the mesh, e.g. if the mesh comprises square openings, the length of the side or diagonal of the openings. In a typical application the arrow head and mesh openings will have a characteristic size of around 50 cm or so, for example. Larger scales, e.g. 1 or 2 meters, or even larger still, may be appropriate for recovering larger or particularly heavy equipment. Similarly, smaller scales may be appropriate in other circumstances.

The typical overall size of the frame 30 will also depend on the application at hand. For recovering receivers used in a typical electromagnetic survey, the frame might have side length of, for example, 5 meters or so. However, bigger or smaller frames can be used. In general, as will be seen further below, larger frames will allow quicker recovery of equipment, especially if their exact location is not known. Smaller frames, on the other hand, will be easier to store, handle and deploy overboard for use. Thus a large vessel seeking equipment that could be located anywhere within a large area would preferably employ a larger frame, for example 10 meters on a side or larger. Whereas a smaller frame, for example 2 meters or so on a side, may be appropriate for small vessel seeking to recover equipment whose location is known more precisely. The accuracy with which the picker can be directed toward the seafloor, which is likely to depend on water depth, will also play a role in determining the most appropriate size. For example, in cases where it is difficult to position the picker, e.g. because of strong currents or in deep water, a larger frame may be preferable.

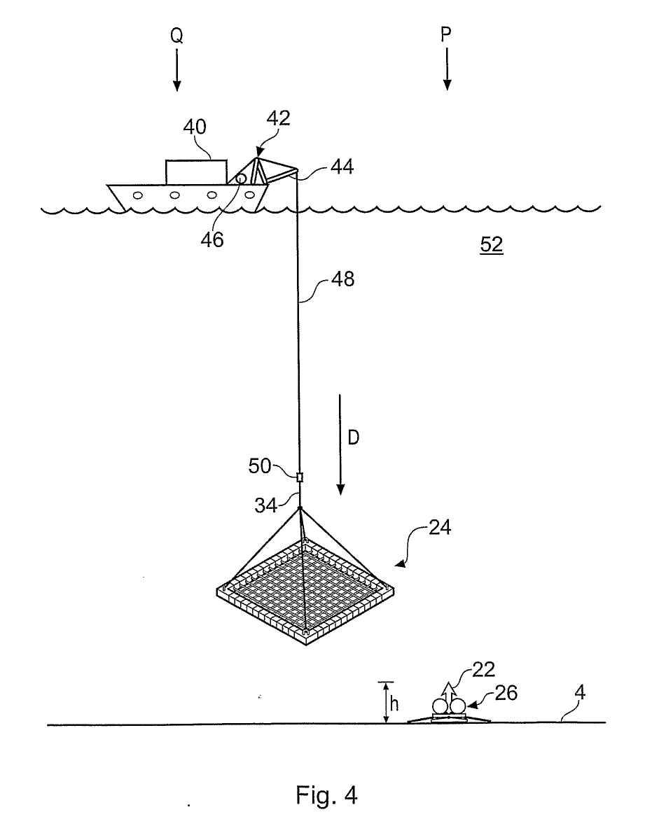

FIG. 4 schematically shows a ship 40 seeking to recover an electromagnetic receiver 26 using the apparatus (harpoon 22 and picker 24) shown in FIGS. 2 and 3 according to an embodiment of the invention. The ship floats on the surface of the body of water 52 in which the receiver 26 has been deployed. The ship 40 may be the vessel supporting the electromagnetic survey, or may be a specialist recovery ship, for example in the case that the apparatus 22, 24 does not provide the primary means of recovery and so is not normally carried on the vessel performing the survey.

In this example it is assumed that the position of the receiver 26 on the seafloor 4 (schematically indicated by arrow P in FIG. 4) is not known. Thus the ship 40 must search for the receiver 26 before it is able to effect recovery. To seek and recover the receiver 26, the ship is positioned at a start position representing a best first guess, or a random guess if there is no preferred staring point, (schematically indicated by arrow Q) and the picker 24 is lowered over the side of the vessel using onboard lifting mechanism 42. The lifting mechanism comprises a crane jib 44 and a winch 46 coupled to a lifting cable 48. The lifting mechanism further includes a conventional load sensitive cell (not shown) operable to provide an indication of the load applied to the lifting mechanism (i.e. the tension in the lifting cable). Lifting mechanisms of this kind are commonly found on ships, especially those used for surveying, and it is likely that any pre-existing lifting mechanism on the ship can be employed with embodiments of the invention. The scale of the lifting mechanism 42, i.e. its load capability, the length of the lifting cable and geometry of the jib 44 which will be appropriate for a given implementation of the invention will depend on the size of the frame, the size and weight of the equipment to be recovered and depth of water, for example. The support cabling 34 is attached to the lifting cable 48 using cable coupling 50 so that the picker 24 can be raised and lowered in the water column using the lifting mechanism according to conventional techniques. Although a separate lifting cable 48 and support cabling 34 are shown, it will be appreciated that a unitary cable could equally be used.

Once the picker 24 has been deployed overboard, the lifting mechanism 42 is driven to lower the picker towards the seafloor, as schematically indicated in FIG. 4 by arrow D. As the picker reaches greater depths, the load cell would indicate an increasing load L associated with the weight of the picker 24 in water plus a uniformly increasing component associated with the increasing weight of the lifting cable as it is played out (assuming the picker is not in free fall). The most useful load to monitor will be the static load, i.e. that seen when the frame is being lowered or lifted at a constant speed or if there is a pause in the lifting or lowering. However, the non-static load, i.e. that seen when there is some acceleration of the picker, may also be used if appropriate account is taken of the acceleration.

A sudden drop in the indicated load occurs when the frame 30 reaches the seafloor and its weight is no longer being supported by the lifting mechanism. The load just prior to this corresponds to the weight of the picker and the weight of the length of lifting cable corresponding to the depth of the water (again assuming the picker is not in free fall). The speed at which the picker is lowered through the water 52 will depend on the rate at which the winch 46 of the lifting mechanism 42 is able to play out the lifting cable 48 and any considerations associated with damaging equipment on the seafloor, or the seafloor itself. For example, in the vicinity of sensitive installations the descent rate may be slowed to minimise the risk of damage caused by the picker 24 dropping on to the seafloor. Having the picker approach the seafloor slowly (at least as it gets closer) will also help prevent damage to the equipment to be recovered in the event that the frame 30 of the picker collides with it.

Once it is determined that the picker 24 is on the seafloor, the playing out of lifting cable by the lifting mechanism is stopped and the lifting mechanism is driven to lift the picker to a height such that the mesh 32 (taking account of any slack in it) would be further from the seafloor than the top of the engagement element 22 (harpoon) attached to the equipment to be recovered, indicated by height h in FIG. 4.

If the static load on the lifting mechanism is indicated as being the same when it is lifted away from the seafloor as it was (at the corresponding height) when it was being lowered to the seafloor, this indicated that the picker has not “picked up” anything, and so the equipment to be recovered has been missed. (Differences in non-static load could also be compared with appropriate account been taken of the effect of the difference in acceleration of the picker between being lowered and lifted.)

Thus the ship moves to another location and tries again. The ship could be moved randomly between locations, but in general it will be more efficient to follow a systematic search plan.

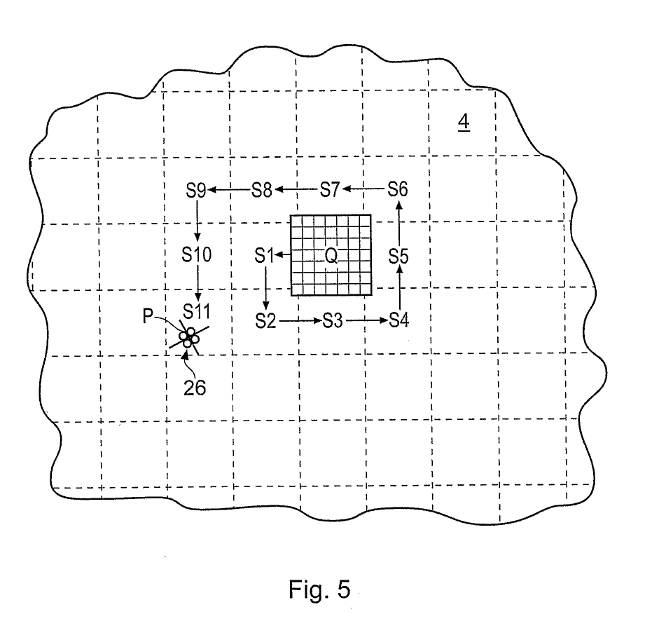

FIG. 5 schematically shows a plan view of the area of seafloor 4 shown in FIG. 4. The picker 24 is at position Q and the receiver 26 to be recovered is shown at position P. Dashed lines are used in FIG. 5 to indicate search grid defining a series of search squares. A search square is searched by positioning the picker 24 over that square and lowering it to, and lifting it from, the seafloor as described above in connection with FIG. 4. Once a square is searched without success (i.e. the picker has been lowered to and lifted from the seafloor with no appreciable change in measured load), the picker is moved to another square. Thus the area is searched square by square. The order in which the squares are searched can be according to any known search technique. For example, a increasing spiral around the start square (containing Q) may be employed. However, it may also be appropriate to take account of the manoeuvreability of the ship and possible differences in the degree of uncertainty in different directions. For example, it may be more appropriate to perform a raster search in strips rather than a spiral search.

The size of the search squares will depend on the size of the frame 30 and the accuracy with which it can be positioned on the seafloor. For example, if the frame can be very accurately positioned, search squares which are only just smaller than the frame size may be appropriate. However, in other cases smaller search squares will be appropriate, for example squares having a characteristic dimension which is half-that of the frame. This can help to ensure areas of seafloor are not missed between neighbouring raise and lower operation. In this case it will be assumed that the search is to be a spiral search and the search squares are only slightly smaller than the frame size, e.g. 90% of it.

At the end of the procedure described above in relation to FIG. 4 for searching the search square containing point Q, the picker is located at a height above the seafloor which is greater than the height h of the harpoon 22. While maintaining this height the ship 40 repositions the picker over the next search square, this square is identified in FIG. 5 as square S1. By maintaining the picker at a height greater than the height of the harpoon, the risk of the picker 24 banging into the equipment to be recovered as the picker is repositioned is reduced. Where the seafloor terrain is rough, or where other equipment is located on the seafloor, it may be preferable to lift the picker 24 higher still as it is moved between search squares. However, in general it will be desirable to keep lift the picker as little as possible during searching to increase search speed.

Once the picker is positioned above search square S1, it is lowered to, and lifted from, the seafloor 4 as described above. The load on the lifting mechanism as the picker is lifted away from the seafloor will again indicate that it has not “picked up” anything, Thus the ship repositions the picker above search square S2 and the search continues, and so on through search squares S3 to s10 as indicated in FIG. 5.

Eventually, following the above described search algorithm, the picker 24 will be positioned above the search square containing the equipment 26 to be recovered, i.e. search square S11 containing point P.

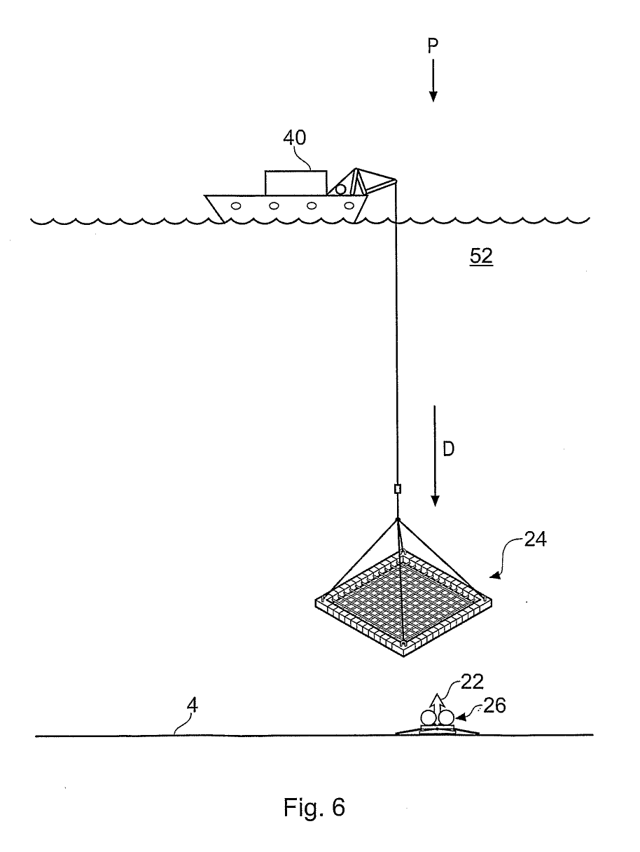

FIG. 6 is similar to and will be understood from FIG. 4. However, in FIG. 6, the search has progressed to search square s11, such that the picker is now above the receiver 26 and in the process of being lowered towards it, as indicated by the arrow D. As the picker approaches the seafloor it lands over the receiver 26. If the mesh 34 is slack, the frame 32 may settle on the seafloor 4 around the receiver with the mesh draped over it. If, on the other hand, the mesh is not sufficiently slack, the frame may be supported to some extent (via the mesh) by the receiver. If the equipment to be recovered is considered delicate, a slack mesh may be preferred to reduce the chance of the equipment having to support the weight of the frame if this is a concern.

In either case, as the picker settles over the receiver, the harpoon 22 passes through the opening in the mesh 32. When the weight of the picker is relieved from the lifting cable, the reduction in load on the lifting mechanism is indicated by the load cell, and the lifting mechanism stops playing out the lifting cable and starts to lift the picker away from the seafloor as described above. However, as this happens the arrowhead on the harpoon 22 snags on (i.e. co-engages with) the netting comprising the mesh 32. Thus as the picker 24 is lifted away from the seafloor 4, the receiver is co-engaged with it and is also lifted. As the picker and receiver clear the seafloor, the load cell indicates that the load on the lifting mechanism is greater than it was as it was being lowered due to the extra weight of the receiver. Thus the operator on the ship or (or an appropriately configured controller if the equipment recovery process is automated) knows that the harpoon 22 has engaged with the mesh 32 and so the search algorithm can stop and the picker can be lifted to the water surface bringing the receiver 22 with it.

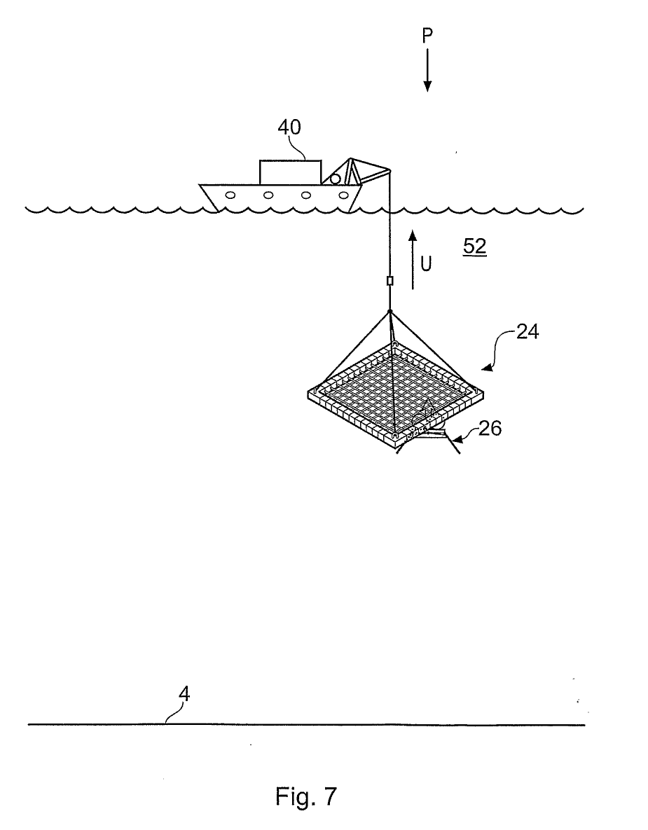

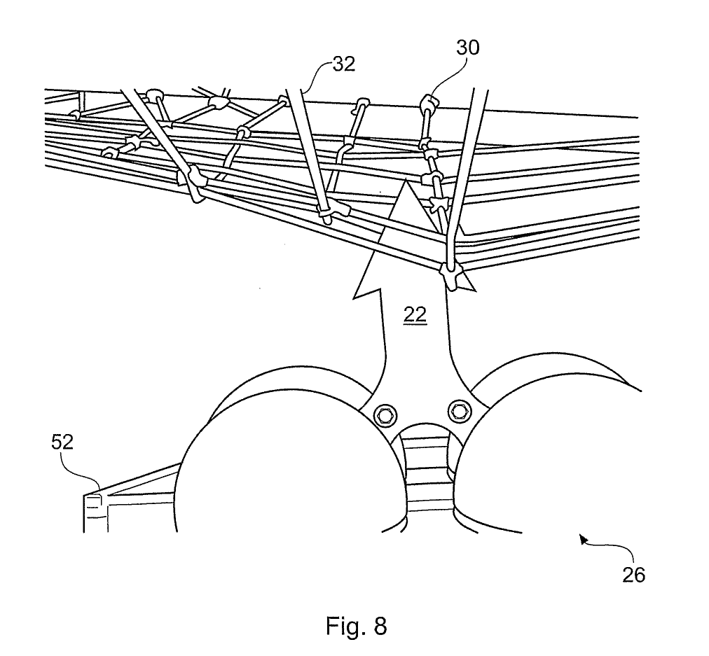

FIG. 8 is similar to and will be understood from FIG. 7. However, FIG. 8 shows the situation after the harpoon 22 and the mesh 32 have become co-engaged, and with the picker 24 and attached receiver 26 being lifted towards the water surface, as indicated by the arrow U.

FIG. 7 schematically shows the co-engagement of the harpoon 22 with the mesh 32 during recovery of the receiver 22 from the body of water 52. FIG. 7 shows the receiver after it has been lifted free of the water surface and is ready to be moved to the deck of the ship to complete the recovery process. The receiver 26 may be deposited on the deck of the ship by appropriate manoeuvring of the picker, or may be separately retrieved from the picker while it is held at the water surface, e.g. using a separate launch.

It will be understood that while recovery of a receiver intended for seafloor deployment and having a conventional primary recovery mechanism (i.e. remotely detachable ballast weight) which has failed has been described above, in other cases a recovery mechanism according to embodiments of the invention will be the primary means of recovery for equipment intended for seafloor deployment. Furthermore, because a suitable engagement element can easily and cheaply be attached to any equipment intended for underwater use, whether or not it is intended to be released onto the seafloor, it can be beneficial to provide the equipment with an engagement element so that it can be recovered as described above in the event it is accidentally dropped or otherwise becomes stranded onto the seafloor.

It some embodiments, the engaging element may be provide with a conventional positioning transponder (e.g. an acoustic transponder) to assist in locating the equipment to be recovered using suitable tracking instruments on the ship and so reduce search time. This can be particularly helpful where the engagement element is to be attached to an item of equipment not normally intended for seafloor deployment as a means of insurance against accidental loss since such equipment is unlikely to have its own positioning transponder.

Furthermore, the picker may also be provided with a positioning transponder to allow its position to be determined. This can help in ensuring the search is effected as efficiently as possible. For example, if both the engagement element (or the equipment to which it is attached) and the picker are provided with a positioning transponder, the positions of each (and hence their positions relative to one another) can be determined so that the picker can be guided towards the equipment to be recovered based on their measured positions.

Information regarding the height of the frame above the seafloor, e.g. from a conventional echo sounder or other depth transducer, may also be provided to allow the picker to be dropped through the seawater as quickly as possible, but slowed down as it approaches the bottom to reduce the chance of damage.

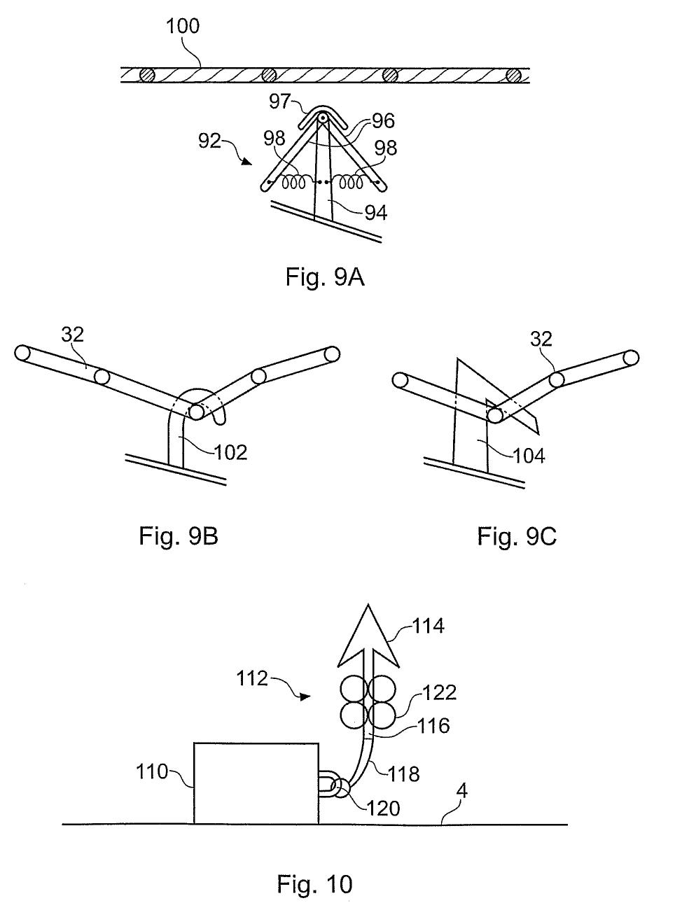

FIGS. 9A to 9C schematically show alternative designs for the engaging end of an engagement element and a portion of a mesh according to other embodiments of the invention.

In FIG. 9A, the engagement element 92 comprises a central support 94 to be attached to equipment prior to its deployment at one end (not shown) and a pair of barb elements pivotably attached to an upper end of the central support. An upper shroud 97 fixed to the central support prevents the barbs from extending beyond a limit angle from the central support, for example beyond 45 degrees or so. A pair of springs 98 urge the barbs 96 open to this limit. The springs are schematically shown in FIG. 9A as helical springs connecting between the central support and the respective bards. However, in practice the springs would be arranged to leave the region under the barbs clear. For example pivot mounted springs may be used. The advantage of this arrangement is that the engagement element can deform when passing through the openings in the mesh and so a rigid mesh could be used. This may be advantageous when heavy loads are to be recovered.

In FIGS. 9B and 9C, the arrowhead design described above is replaced with a single hook design (FIG. 9B) and a single barb design (FIG. 9C). It will be appreciated that many other designs could be used, for example the engagement element is not constrained to a generally planar form and designs based on barbs, hooks, hitches etc extending in several directions could be used which allow the engagement element to pass easily through a mesh lowered onto it, but to snag on the mesh as it is lifted upwards. In general, the most appropriate design for the engagement element may also depend on characteristics of the equipment to be recovered. For example, its mass in water, mass in air, shape and balance, sensitivity to extra appendages and so on.

FIG. 10 schematically shows an engagement element which may be used in cases where it cannot be predicted which orientation the equipment to be recovered will adopt on the seafloor. In this example it is assumed that the equipment is a cuboid box 110 that has been accidentally dropped on to the seafloor 4. The engagement element 112 comprises an arrow head 114, a shaft 116 and a buoyancy device 122 and a flexible coupling 118, (e.g. rope or chain). The flexible coupling 118 is attached to the equipment 110 in advance of the time it is accidentally lost (i.e. it may be attached before the equipment 110 enters the water, or at a later stage, e.g. when it is already underwater, but is about to be moved and so there is a risk of dropping it). When the equipment 110 is dropped to the seafloor, the flexible coupling and buoyancy device ensure that the arrow head part of the engagement element remains pointing upwards. This it may be recovered as described above by lowering a mesh onto it. The buoyancy device 122 may be, for example, one or more air filled chambers a volumes of polystyrene or other buoyant material. Because the engagement element 112 is not rigidly mounted, there is an increased chance that it will not pass through the mesh but will be simply pressed down by it. In cases such as this where it is considered that there is a reasonable chance of the harpoon and mesh not engaging with each other, multiple several lifts and drops in each search square may be executed to help avoid missing the equipment.

In deep water, the combined weight of the picker and the length of lifting cable required to reach the seafloor may mean it is difficult to reliably sense the additional weight of the equipment (e.g. because underwater currents or surface heave cause variations in load which are significantly greater than the weight of the equipment). In cases such as this, it may be beneficial to locate the load cell not on the surface vessel, but closer to the picker (with an appropriate communications link to the surface) so that the weight of cable above the load cell does not effect the measurement. Likewise, in cases where particular sensitivity is required, it may be beneficial to locate the load cell within the mesh itself. By providing a strain gauge (or multiple strain gauges) within the webbing comprising the mesh, a significant change in measured load can be apparent even for relatively light equipment, so long as the equipment has a measureable weight compared to the weight of the mesh supported through the strain gauge (or other form of load cell).

Thus there has been described an apparatus and method for recovering equipment from within a body of water. The apparatus comprises a frame supporting a mesh and an engagement element. The engagement element is shaped to co-engage with the mesh and is attached to the equipment to be recovered prior to its deployment. Following deployment of the equipment, its recovery can be effected by lowering the mesh supported by the frame onto the equipment to cause the engagement element and the mesh to co-engage. The frame and mesh may then be lifted to the surface of the water, bringing the equipment with them. Recovery may include searching for the equipment by monitoring a load associated with the frame and the mesh as it is lowered and raised at different locations, whereby an appropriate increase in load is taken to indicate that the equipment has become attached to the mesh. Thus embodiments of the invention provide a simple, cheap and reliable apparatus and method for recovering underwater equipment. Embodiments of the invention provide benefits such as:
The apparatus is simple and easy to operate, it requires no special materials or tolerances and inflicts minimum damage to the seafloor
Any sub-sea equipment can be fitted with an engagement element with ease and at low cost which ensures its recovery using a mesh supported on a frame at any time in the future for a fraction of the cost of traditional recovery methods (diver/ROV).
The frame size can be varied according to the area to be searched and there is no limitation on water depth, as there would be using remotely operated vehicles or divers.
Because of the frame size large areas can be covered far more quickly and effectively that traditional grappling methods.
In areas of environmental sensitivity, instruments/moorings can be recovered leaving nothing on the seafloor, in contrast to standard acoustic deployment/recovery methods, which leave a bottom weight on the seafloor after recovery.

Thus the apparatus may be used to easily recover instruments or other equipment that have been placed or moored on the seafloor in a variety of water depths, on purpose or accidentally, without the need for acoustically activated release mechanisms. The device is economical to construct and requires deployment equipment that is fitted as standard to most vessels involved in sub-sea projects. The device is easily dismantled and takes up minimal space whilst not in use. If required it can be constructed locally to the project as no specialized materials or tolerances are required. Almost any item that may be placed on the seafloor, towed at depth, moored or accidentally lost, regardless of size, shape or water depth can be recovered using the apparatus significantly more easily and cheaply than with currently available methods.

### REFERENCES

[1] GB 2382875 A1 (University of Southampton)
[2] U.S. Pat. No. 5,770,945 (Constable)
[3] EP 1188662 (Pfitzner)
[4] GB 2279319 (Bolton)
[5] U.S. Pat. No. 6,843,191 (Makotinsky)

1. A method for recovering underwater equipment from within a body of water comprising:
attaching an engagement element to the equipment prior to its deployment; and, following deployment of the equipment:
lowering a mesh supported by a frame through the body of water and onto the equipment to cause the engagement element and the mesh to co-engage; and
lifting the frame and the mesh and the equipment attached thereto upwards to recover the equipment.

2. A method according to claim 1, further comprising monitoring a load associated with the frame and mesh to determine whether they are supporting the weight of the equipment.

3. A method according to claim 2, further comprising searching for the equipment by lowering and lifting the frame and mesh at different locations until an increase in the load being monitored indicates that the equipment has become attached to the mesh via the engagement element, and then lifting the frame and the mesh and the equipment attached thereto upwards to recover the equipment.

4. A method according to claim 3, wherein the frame and mesh are maintained at a height greater than that of the equipment and attached engagement element as they are moved between the different locations.

5. A method according to claim 3, wherein the distance between one location and a subsequent location is less than the width of the frame.

6. A method according to claim 1, wherein the frame and mesh are lowered and raised multiple times at a location to improve the chance of the engagement element and the mesh co-engaging.

7. Apparatus for recovering equipment from within a body of water, comprising:
a frame supporting a mesh configured to sink in the body of water when in normal use; and
an engagement element configured to be attached to the equipment to be recovered prior to the equipment's deployment and shaped to co-engage with the mesh in the event that the mesh is lowered onto the engagement element.

8. Apparatus according to claim 7, wherein the engagement element has an end in the form of an arrow head.

9. Apparatus according to claim 7, wherein the engagement element has an end in the form of a hook.

10. Apparatus according to claim 7, wherein the engagement element has an end in the form of a barb.

11. Apparatus according to claim 7, wherein the mesh is flexible.

12. Apparatus according to claim 7, wherein the mesh is rigid.

13. Apparatus according to claim 7, wherein the engagement element includes a buoyancy device so that its orientation is maintained when submerged.

14. Apparatus according to claim 7, further comprising a device for measuring a load associated with the frame and the mesh as it is lifted.

15. Apparatus according to claim 7, wherein the engagement element includes a position transponder.

16. Apparatus according to claim 7, wherein the frame includes a position transponder.

17. Apparatus comprising equipment to be recovered with the engagement element of claim 7 attached thereto.
